(19) United States
(12) Patent Application Publication
(10) Pub. No.: US 2007/0225194 A1
(43) Pub. Date: Sep. 27, 2007

(54) Household and Industrial Cleaners and Methods for Making and Using Them

(75) Inventors: Robert K. Larsen, Sandy, UT (US); Calvin D. Ostler, Riverton, UT (US)

Correspondence Address: GEOFFREY E. DOBBIN, PATENT ATTORNEY, 4278 SOUTH 6220 WEST, WEST VALLEY CITY, UT, 84128-6501, US

(73) Assignee: CAO GROUP, INC., West Jordan, UT (US)

(21) Appl. No.: 11/738,376

(22) Filed: Apr. 20, 2007

Related U.S. Application Data
(63) Continuation-in-part of application No. 10/923,502, filed on Aug. 20, 2004, now abandoned.

(51) Int. Cl. C11D 3/00

(52) U.S. Cl. 510/375

(57) ABSTRACT

The addition of the Iodide ion by way of Potassium Iodide to a peroxide such as Hydrogen Peroxide in a basic medium yields Free Radical Oxygen and water; generating large amounts of heat and depleting the Hydrogen Peroxide in a matter of minutes. The Free Radical Oxygen generated in this reaction can be utilized to oxidize organic molecules that produce offending stains on select items. Once the Free Radical Oxygen has oxidized the offending molecule the color is lost and the solubility changes allowing the colorless oxidized fragments of the offending molecule to be washed away in the solvent. The Iodide ion catalyzes the reaction allowing for precise control over the speed at which the stain is removed without the need for other expensive, cumbersome energy adding equipment such as lights, lasers, heat sources, etc.

### CROSS-REFERENCES TO RELATED APPLICATIONS

This patent application is a Continuing-in-Part Application and claims benefit to and the priority of its parent, U.S. utility application Ser. No. 10/923,502 filed on Aug. 20, 2004, which in turn claims priority on U.S. utility patent application Ser. No. 10/797,628 filed on Mar. 10, 2004. Both Applications are hereby incorporated by reference in their entirety.

### FIELD OF THE INVENTION

The present invention relates to the field of household and industrial cleaners more particularly relates to such cleaners utilizing a combination of iodide and hydrogen peroxide in a generally basic medium. For the purposes of this Application, this Specification and the appended Claims, household cleaners includes those products that are primarily manufactured for and customarily used in the cleaning of surfaces, utensils, appliances and other equipment found in a house. Likewise, industrial cleaners are defined as primarily manufactured and customarily used in the cleaning of surfaces, utensils, tools and other equipment in an industrial setting. Industrial cleaners tend to be, though are not always, more concentrated solutions of household cleaners

### BACKGROUND OF THE INVENTION

Cleaners for household and industrial uses are known in the prior art. Many of these materials utilize a surfactant and a carrier solution to break up grease and stains. Often an abrasive may be added. This goal is accomplished because surfactants tend to bond with the compounds and elements within staining and offending material, thereby breaking up a stain and removing it. Sometimes, a source of oxygen free-radicals, like peroxide, is also provided with the cleaner. Free radical oxygen binds with stains on an atomic level and eliminates them. Various methods of improving peroxide performance are also known in the prior art, as anything that will stimulate free-radical oxygen production will generally improve basic performance of a bleaching product. The use of iodine, in particular potassium iodide, with hydrogen peroxide is also known in the field of antiseptics. The use of the hydrogen peroxide as an astringent and the iodine as an antiseptic provide a useful combination when treating minor cut and abrasions. These combinations rely on the disinfecting power of the iodine for their utility, and prefer that the iodine is active and present. This occurs in an acidic environment and leaves the resultant solution of iodine and hydrogen peroxide with the all too familiar reddish-brown staining color associated with antiseptic iodine. There is even some prior art that suggests the use of potassium iodide and peroxide as a cleaner for contact lenses, which requires a pH above 6 in order to limit the iodine coloration, but this still relies on the iodine as a disinfectant and is stated to be used in a preferred pH range of around 7. Starting at a level of approximately 7.5 pH, the relation between tri-iodide molecules and oxygen radicals in the solution changes as the iodine is kept bound in solution as a catalyst and more radicals are released. While it is known that O₂ is formed from the reaction, free-radical Oxygen production from the reaction has been, at best, ignored. The parent Application and its parent have gone into extensive detail in the prior art and the reader is directed to that discussion, which has already been incorporated by reference above.

The present invention, in its preferred embodiment, are household and industrial cleaners presented in a binary solution system, utilizing potassium iodide as a catalyst for generation of free-radical oxygen. The cleaners are kept in a binary solution, having two separate components that are combined when desired to be used.

The present invention represents a departure from the prior art in that the cleaners of the present invention utilize iodide, which precipitates to the stain-causing elemental form at acidic pH levels, as a catalyst in solutions at a basic pH for creating bleaching oxygen radicals in peroxides, thereby increasing whitening effectiveness.

### SUMMARY OF THE INVENTION

In view of the foregoing disadvantages inherent in the known types of cleaners, this invention provides improved cleaners with greater efficiency. To accomplish these objectives, a cleaner according to the present invention, in its most basic embodiment, comprises a peroxide based active component and an iodide based catalyst that are kept separate until use.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a depiction of the bleaching, or whitening, reaction.

FIG. 2 depicts a twin chambered containment and mixing vessel for cleaner.

FIG. 3 depicts a tabletized cleaner.

FIG. 4 depicts dispensing a cleaner.

FIG. 5 depicts use of a cleaner.

### DETAILED DESCRIPTION OF THE PREFERRED EMBODIMENT

With reference now to the drawings, the preferred embodiment of the bleaching gels are herein described. It should be noted that the articles “a”, “an”, and “the”, as used in this specification, include plural referents unless the content clearly dictates otherwise.

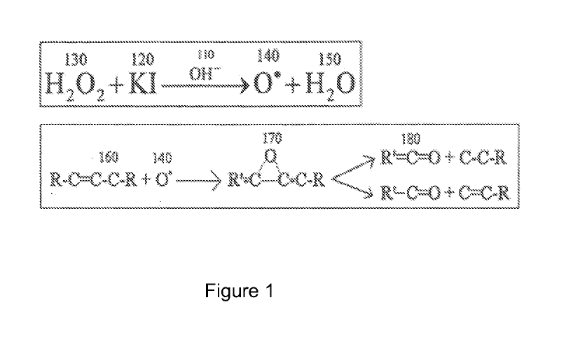

With reference to FIG. 1, it is well established that the free radical oxygen atoms (140) liberated from peroxides such as hydrogen peroxide (130), carbamide peroxide, and salts of peroxides formed from the alkali and alkaline earth metals, readily attack and oxidize organic molecules (160) that comprise the stains in discolored teeth. It is also well established that a release of free radical oxygen atoms from the peroxides can be accelerated by the addition of heat, light and/or chemicals; specifically chemicals that raise the pH of the peroxide environment. A lengthy dissertation of the exact mechanisms is discussed in prior work found in U.S. Pat. No. 6,116,900, “Binary energizer and peroxide delivery system for dental bleaching” which is herein incorporated by reference.

For whitening and bleaching purposes, the addition of the Iodide ion by way of Potassium Iodide (120) to a peroxide such as Hydrogen Peroxide (130) in a basic medium (110) yields Free Radical Oxygen (140) and water (150); generating large amounts of heat and depleting the Hydrogen Peroxide fairly rapidly given a set relative amount of iodide in the system. The Free Radical Oxygen (140) generated in this reaction can be utilized to oxidize organic molecules that produce offending stains (160) on select items, including teeth. Once the Free Radical Oxygen has oxidized the offending molecule (170) the color is lost and the solubility changes allowing the colorless oxidized fragments (180) of the offending molecule to be washed away in the solvent.

It should be noted that earlier uses of iodine and peroxide were antiseptic in nature and utilized free iodine. The uses of these compositions required the medium to have pH in a neutral to acidic ranges, as free iodine is eliminated as pH is raised to a basic range, beginning somewhere between a pH of 6.5 and 7.5. This invention does not use free iodine. In the basic range, in particular 7.5 and above, the peroxide decomposition yields a large number of oxygen free radicals in a short period of time while free iodine is eliminated. This combination is especially effective in bleaching applications. As such, any free iodine left in solution is of a negligible amount and not considered relevant to the invention.

The composition could be thickened into a gel form. The term “gel” is defined in this document, as a product that, when applied to a surface will tend to adhere to the surface rather than immediately running off in order to aid in providing a whitening treatment. Therefore the “gel” could also be a thick paste or a very runny or “loose gel.” A gel may be created with or without a thickener or viscosity increaser. The exact formulations for various gels has been exhaustively studied and reported. Any gel that is stable can be utilized. Examples of gelling materials include but are not limited to the long list of polyacrylic acid thickeners most commonly sold under the trade name Carbopol by the BF Goodrich Company; the gum thickeners such as guar gum and xantham gum; the cellulose thickeners such as methyl cellulose, sodium carboxymethyl cellulose, hydroxyethyl cellulose, hydroxpropyl methyl cellulose and hydroxymethyl propyl cellulose; glycerin and its derivatives; the silica thickeners such as fumed silica and silica aerogel thickener; glycol and its many derivatives such as propylene glycol, polyethylene glycol, and polypropylene glycol; polyoxyethylene polyoxypropylene block copolymeric thickeners available under the trade name PLURONIC available from BASF, cross-linked copolymers of acrylic acid and a hydrophobic comonomer available under the trade name PEMULEN from the BF Goodrich Company, and other thickeners such as sorbitol and polyvinyl alcohol. Polyvinylpyrrolidone is particularly attractive as it provides a gel that is stable across a wide range of pH values. Polyvinylpyrrolidone is also an iodophor. An iodophor is any surface active agent or polymer that acts as carriers and solubilizing agents for iodine. Virtually any thickener may be used provided that it is safe for human exposure and stable in the environments. All of these thickening agents are readily available from the standard chemical sources such as Sigma-Aldrich of Milwaukee, Wis. and Spectrum Chemicals of Gardena Calif. Examples of gels are provided in the parent application referenced above and are specifically incorporated here by reference.

An additional feature that is supplied first by way of the rapid pH changes involved in the ion catalyzed “decomposition” of peroxide and, second, the highly aggressive oxidation and cleavage of organic molecules by the free radicals produced is that changing colors may be part of the system. For instance if an indicator such as thymolphthalien which is blue in the very basic range and clear in the near neutral range was combined with a dye that is readily attacked and destroyed by the free radicals such as betacarotene, FD&C Red 40, or Amaranth in the non-peroxide compartment, when the peroxide compartment and the non-peroxide compartment contents are mixed the color would immediately change from indigo blue to red. Over a time frame determined by the concentration of dye present, the red color would fade leaving a clear-colorless gel. If allowed to stand long enough the system, as it rebounds to the basic side, would turn a light blue color. The color could be used to demonstrate the system is active as the indigo blue turns to red. The red color could serve asan indication that the peroxide is exhausted as the red color fades Additionally, FD&C Yellow 5 could be added. Yellow 5 is stable in the presence of free radicals generated by this system. The color would then go from indigo blue, to orange, to yellow to green . . . depending on the various concentrations. A number of combinations of pH indicators and dyes are possible with the system and could lend themselves to a variety of uses.

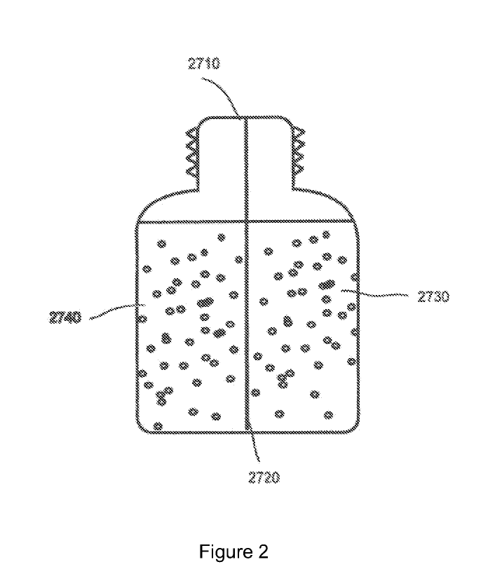

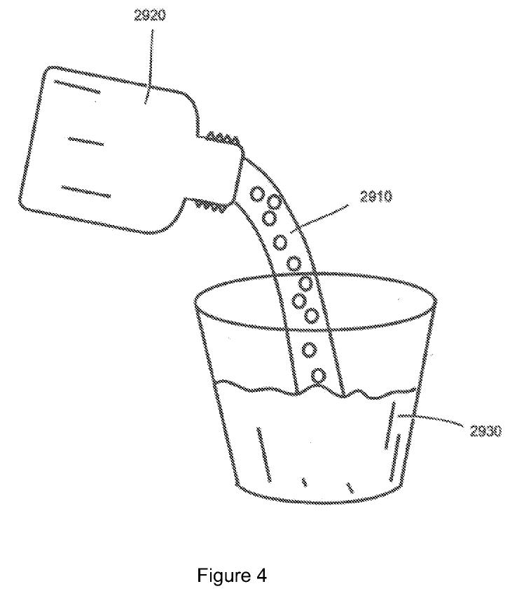

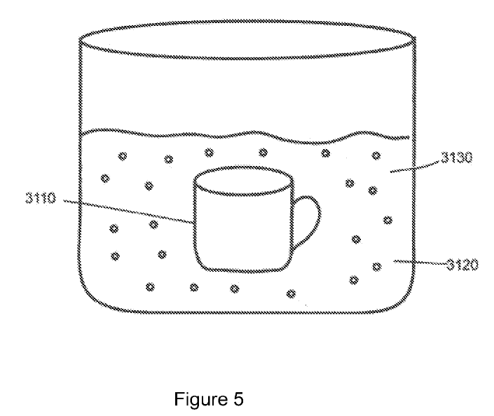

The delivery mechanism and method can be any system that keeps the two components separate until immediately prior to use. Maintaining separation of the two components is necessary as the reaction between the peroxide and iodide will deplete the peroxide too rapidly for the composition to be manufactured, shipped, and stored as a combined solution. The composition can be a binary system comprised of two liquid phases. The delivery device can be as simple as packaging the two liquid phases in two separate containers. The consumer would then dispense appropriate amounts of both phases into a suitable container, a drinking glass or dish. A more convenient packaging and delivery system is illustrated in FIG. 2. In such a system the peroxide containing phase is isolated in its own chamber (2710) by a wall (2720) from the non-peroxide containing phase isolated in its own chamber (2730). Such a configuration, refer to FIG. 4, allows the consumer to simply pour both phases (2910) from the container (2920) simultaneously into a suitable container (2930). Refer to FIG. 5, once the components (3120) are dispensed into a suitable container (3130), the consumer then places the stained object, in this case a coffee cup (3110) in the solution for the prescribed amount of time. The prescribed amount of time being dependent upon the concentration of peroxide and iodide present. In the example depicted below in Table 1, the prescribed amount of time would be between 30 and 45 minutes or until the color change indicates and exhaustion of the peroxide. The object is then removed from the container, rinsed of with water, and is bright and white ready to use.

TABLE 1

| | Energizer Phase | Peroxide Phase |
|---|---|---|
| Ingredient | % by weight | % by weight |
| Potassium Hydroxide | .06 | 0.0 |
| Potassium Iodide | 0.50 | 0.0 |
| Hydrogen Peroxide, 50% aqueous | 0.0 | 12.0 |
| Ion Scavenger (Di-sodium EDTA) | 0.0 | 0.02 |
| Citric Acid | 0.0 | 0.02 |
| Additional Ingredients (Dyes, | 0.0-10.0 | 0.0 |
| Indicators etc.) | | |
| Deionized or Distilled Water | (QS) | (QS) |

The present example was used, in our laboratory, to remove severe coffee stains from a coffee cup and to remove tomato paste stains from a plastic container. In both cases the system performed magnificently.

A second example enables the consumer to save money by providing their own source of peroxide and purchasing the catalytic phase in “concentrated” form. Hydrogen peroxide is inexpensive and readily available at most drug stores and grocery stores. The concentration of Hydrogen Peroxide that is commonly sold to consumers is 3% and is considered safe for consumers. Three percent Hydrogen Peroxide is the ultimate concentration of Example 1 as well. The consumer dispenses the prescribed amount of Energizer Phase and the prescribed amount of 3% Hydrogen Peroxide into a suitable container and mixes it. In this example the consumer would place one teaspoon of the Energizer Phase Concentrate into one cup of 3% Hydrogen Peroxide. Refer to FIG. 5. Once the mixture (3120) has been placed in a suitable container (3130), the consumer places the object, in this case a coffee cup (3110), in the solution for the prescribed amount of time. The prescribed amount of time being dependent upon the concentration of peroxide and iodide present. In this example, shown in Table 2, the prescribed amount of time would be between 30 and 45 minutes or until the color change indicates and exhaustion of the peroxide. The object is then removed from the container, rinsed of with water, and is bright and white ready to use.

TABLE 2

| | Energizer Phase “Concentrate” |
|---|---|
| Ingredient | % by weight |
| Potassium Hydroxide | 1.45 |
| Potassium Iodide | .362 |
| Additional Ingredients (Dyes, | 0.0-10.0 |
| Indicators etc.) | |
| Deionized or Distilled Water | (QS) |

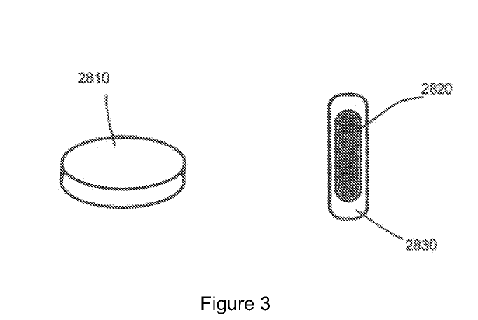

A third example provides the greatest degree of convenience for the consumer. The peroxide in this case is in solid form enabling complete packaging in a single package. The consumer need only supply tap water to the system. Having the system in a solid form facilitates a variety of convenient ‘unit of use’ packaging forms. For instance the solid could be measured out and sealed in plastic envelopes that could then be opened added to the water by the consumer. Refer to FIG. 3, the solid could be pressed into tablet form (2810). Additionally, the active ingredients of the tablet (2820) could be coated with a water soluble material (2830) such as gelatin. Such a coating would have the benefit of isolating the consumer from the solid components. In such a form the consumer need only drop the prescribed number of tablets into tap water and mix until dissolved. Additionally, the solid could be placed directly, without compressing it into a tablet, into a water soluble shell, such as a gelatin capsule. Again, in this form the consumer is completely isolated from the solid components. The consumer need only drop the prescribed number of capsules into tap water and mix until dissolved. In any of these forms the system becomes very quick and convenient to use.

The consumer dispenses the prescribed amount of Energizer Phase Solid, in any of the forms discussed above, into a suitable container, a drinking glass or dish, which contains the prescribed amount of tap water and then stirs the mixture until the solids dissolves. Refer to FIG. 5, once the mixture (3120) is prepared and placed into a suitable container (3130) the consumer places the object, in this case a coffee cup (3110), in the solution for the prescribed amount of time. The prescribed amount of time being dependent upon the concentration of peroxide and iodide present. In this example, shown in Table 3, the prescribed amount of time would be between 30 and 45 minutes or until the color change indicates and exhaustion of the peroxide. The object is then removed from the container, rinsed off with water, and is bright and white ready to use.

TABLE 3

| | Energizer Phase “Solid” |
|---|---|
| Ingredient | % by weight |
| Potassium Hydroxide | 1.9* |
| Potassium Iodide | 4.1* |
| Carbamide Peroxide | 94.0* |
| Additional Ingredients (Dyes, | 0.0-10.0 |
| Indicators etc. in Solid Form)* | |

*as the additional ingredients are added the percentages need to be recalculated.

The above examples all relate to a soaking method of cleaning stains off of a coffee cup. It is to be understood that other surfaces may be cleaned with these solutions and the coffee cup is only an example surface to be cleaned. Obviously, the solutions may be placed on a surface or object, rather than having an object submerged in the solution, and have a similar effect, as long as peroxide is available to provide oxygen free radicals. Other cleanable surfaces include counters, appliances, floors, toilets, sinks, industrial tools and machines, color safe fabrics (carpet, upholstery). Laundry is especially suited to cleaning with solutions presented in the third, “dry,” example as tablets or capsules need only be dropped into the washing machine tub. Non-submergible surfaces benefit from viscous solutions that have been gelled as discussed above. These solutions are applied to the surface and rinsed when cleaning is finished. It is to be understood that the concentration of the cleaning solutions will vary according to packaging and intended use. Industrial cleaners will tend to be stronger concentrations than household cleaners. Cleaning solutions may be presented ready for use, say on a household appliance or floor, or concentrated for later dilution, like the earlier laundry example. Such variations of concentration for use are considered easily understood and conceivable in the art and are considered a part of the disclosed invention.

Although the present invention has been described with reference to preferred embodiments, numerous modifications and variations can be made and still the result will come within the scope of the invention. No limitation with respect to the specific embodiments disclosed herein is intended or should be inferred.

What is claimed is:

1. A cleaning composition for household and industrial purposes, the composition comprising a peroxide and some form of the element iodine in a basic medium.

2. The composition of claim 1, the composition being a binary composition, that is having the peroxide and the iodine physically separated in different components until use of the compound is desired, whereupon the components are then combined to make the composition.

3. The composition of claim 2 having a pH over 7.5.

4. The composition of claim 2 having a pH between 8 and 9, inclusively.

5. The composition of claim 2, the composition having no more than negligible free iodine after combination of the components.

6. The composition of claim 1, the peroxide being hydrogen peroxide.

7. The composition of claim 1, the iodine being in the form of potassium iodide.

8. The composition of claim 1, the iodine being in the form of potassium iodide and the peroxide being hydrogen peroxide.

9. The composition of claim 8 having a pH over 7.5.

10. The composition of claim 8 having a pH between 8 and 9, inclusively.

11. The composition of claim 8, the composition having no more than negligible free iodine after combination of the components.

12. A system for containing and dispensing a cleaner for household and industrial uses, the system comprising:
a. A vessel, said vessel further comprising two chambers, both with selectable fluid communication with a mixing chamber, said mixing chamber not necessarily being a part of the vessel;
b. a catalyst component containing some form of the element iodine, stored in one chamber; and
c. a bleaching component containing peroxide, stored in the other container;
wherein use of the system is stored with the chambers having no fluid communication with the mixing apparatus and fluid communication being established when the system is used and the components are mixed into a resultant composition.

13. The system of claim 12, the composition having a pH over 7.5.

14. The system of claim 12, the composition having a pH between 8 and 9, inclusively.

15. The system of claim 12, the composition having no more than negligible free iodine after combination of the components.

16. The system of claim 12, the peroxide being hydrogen peroxide.

17. The system of claim 12, the iodine being in the form of potassium iodide.

18. The system of claim 12, the iodine being in the form of potassium iodide and the peroxide being hydrogen peroxide.

19. The system of claim 18, the composition having a pH over 7.5.

20. The system of claim 18, the composition having a pH between 8 and 9, inclusively.

21. The system of claim 18, the composition having no more than negligible free iodine after combination of the components.
